(19) United States
(12) Patent Application Publication
(10) Pub. No.: US 2019/0136803 A1
(43) Pub. Date: May 9, 2019

(54) EGR GAS DISTRIBUTOR

(71) Applicant: AISAN KOGYO KABUSHIKI KAISHA, Obu-shi (JP)

(72) Inventors: Kaisho SO, Nagoya-shi (JP); Mamoru YOSHIOKA, Nagoya-shi (JP); Akinari YASUE, Tokai-shi (JP)

(73) Assignee: AISAN KOGYO KABUSHIKI KAISHA, Obu-shi (JP)

(21) Appl. No.: 16/168,270

(22) Filed: Oct. 23, 2018

(30) Foreign Application Priority Data
Nov. 8, 2017 (JP) 2017-215417

(51) Int. Cl. F02M 35/104; F02M 35/10; F02M 26/35; F02M 26/17

(52) U.S. Cl. CPC F02M 35/1045; F02M 26/17; F02M 26/35; F02M 35/10222

(57) ABSTRACT

An EGR gas distributor for distributing EGR gas to each of a plurality of branch pipes of an intake manifold includes a gas chamber, a chamber case extending in a direction traversing the branch pipes, a gas inflow pipe provided in the chamber case and configured to introduce EGR gas to the gas chamber, a plurality of gas distribution pipes branched from the chamber case and arranged at intervals in a longitudinal direction of the chamber case to distribute EGR gas from the gas chamber to each of the branch pipes, and a condensed-water flow restraining unit for restraining condensed water generated in the gas chamber from flowing in the gas distribution pipes.

### CROSS-REFERENCE TO RELATED APPLICATIONS

This application is based upon and claims the benefit of priority from the prior Japanese Patent Application No. 2017-215417 filed on Nov. 8, 2017, the entire contents of which are incorporated herein by reference.

### BACKGROUND

### Technical Field

The present disclosure relates to an EGR (Exhaust Gas Recirculation) gas distributor to be attached to an intake manifold in use to distribute EGR gas to a plurality of cylinders of an engine.

### Related Art

As the above type of technique, conventionally, there has been known an EGR gas distribution part provided in an intake device (an intake manifold) disclosed in Japanese unexamined patent application publication No. 2016-089687 (JP2016-089687A). This intake manifold will be mounted together with an engine in a vehicle and is provided with a surge tank and a plurality of intake pipes (branch pipes) branched from the surge tank in one-to-one correspondence to cylinders of the engine. The EGR gas distribution part is configured to distribute EGR gas to each of the branch pipes. This EGR gas distribution part includes a gas inflow pipe connected to an EGR gas supply source, an upstream-side gas distribution pipe bifurcated from the gas inflow pipe, a gas chamber to collect EGR gas flowing from this gas distribution pipe, and a plurality of downstream-side gas distribution pipes branched from the gas chamber and connected to each of the branch pipes. This EGR gas distribution part has a bilaterally symmetrical shape with respect to the center axis of the gas inflow pipe to allow EGR gas introduced into the gas chamber through the gas inflow pipe to be distributed to each of the branch pipes through the corresponding downstream-side gas distribution pipes.

### SUMMARY

### Technical Problem

However, in the EGR gas distribution part disclosed in JP2016-089687A, for example, during cold start or the like of the engine, condensed water may be generated in the gas chamber from water or moisture contained in the EGR gas. This condensed water may adhere to an inner wall of the gas chamber or flow down by its own weight along the inner wall and accumulate in a lower area (a lowermost portion) of the gas chamber. If the amount of the condensed water generated therein increases, the condensed water may flow in the downstream-side gas distribution pipe(s) and further into the corresponding branch pipe(s) and then be sucked into the cylinder(s) of the engine. This suction of condensed water into the engine may cause misfire in the engine.

The present disclosure has been made to address the above problems and has a purpose to provide an EGR gas distributor capable of preventing the condensed water generated in a gas chamber from being sucked into an engine through gas distribution pipes and branch pipes of an intake manifold.

### Means of Solving the Problem

To achieve the above-mentioned purpose, one aspect of the present disclosure provides an EGR gas distributor that is an attachment device to be attached to an intake manifold and is configured to distribute EGR gas to each of a plurality of branch pipes constituting the intake manifold, the EGR gas distributor comprising: a chamber case including a gas chamber configured to allow the EGR gas to flow therein, the chamber case extending in a direction traversing the plurality of branch pipes; a gas inflow pipe provided in the chamber case and configured to introduce the EGR gas into the gas chamber; a plurality of gas distribution pipes branched from the chamber case and arranged at intervals in a longitudinal direction of the chamber case to distribute the EGR gas to the plurality of branch pipes; and a condensed-water flow restraining unit configured to restrain condensed water generated in the gas chamber from flowing into the gas distribution pipes.

The foregoing configuration can restrain condensed water generated in the gas chamber from being sucked into the engine through the gas distribution pipe and the branch pipes of the intake manifold and thus prevent misfire in the engine due to suction of the condensed water.

### BRIEF DESCRIPTION OF THE DRAWING

FIG. 1 is a perspective view of an EGR gas distributor in a first embodiment;

FIG. 2 is a perspective view of the EGR gas distributor attached to an intake manifold in the first embodiment;

FIG. 3 is a cross-sectional view of the EGR gas distributor and the intake manifold shown in FIG. 2, taken along a vertical plane perpendicular to a longitudinal direction of the EGR gas distributor at a position corresponding to one gas distribution pipe in the first embodiment;

FIG. 4 is a perspective cutaway view of a part of the EGR gas distributor and a part of the intake manifold shown in FIG. 2 in the first embodiment;

FIG. 5 is a cross-sectional view of an EGR gas distributor in a second embodiment, corresponding to FIG. 3;

FIG. 6 is a cross-sectional view of an EGR gas distributor in a third embodiment, corresponding to FIG. 5;

FIG. 7 is a cross-sectional view of the EGR gas distributor in the third embodiment, corresponding to FIG. 5;

FIG. 8 is a cross-sectional view of an EGR gas distributor and others (including a partial cutaway view of some devices) in a fourth embodiment; and

FIG. 9 is a cross-sectional view of an EGR gas distributor in another embodiment, corresponding to FIG. 3.

### DETAILED DESCRIPTION OF THE EXEMPLARY EMBODIMENTS

### First Embodiment

A detailed description of a first embodiment of an EGR gas distributor will now be given referring to the accompanying drawings.

(Relationship Between EGR Gas Distributor and Intake Manifold)

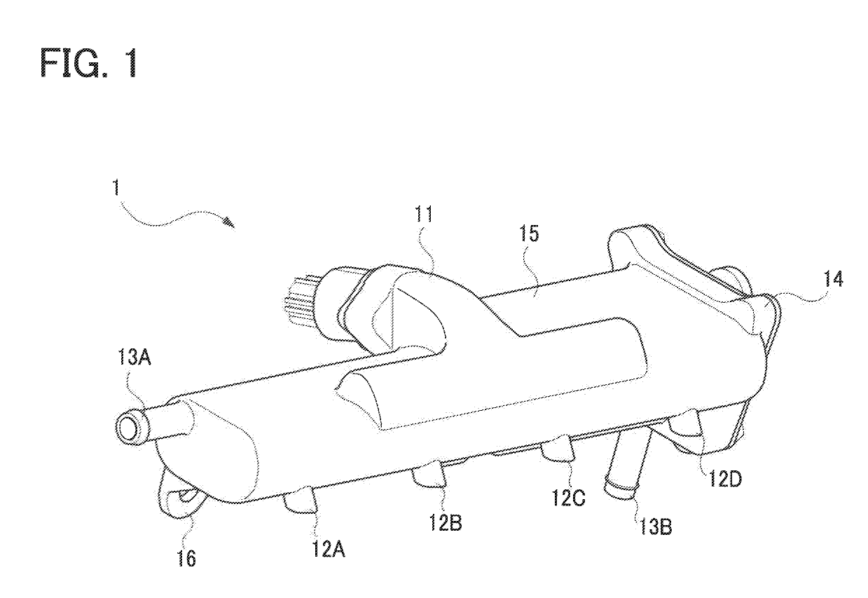

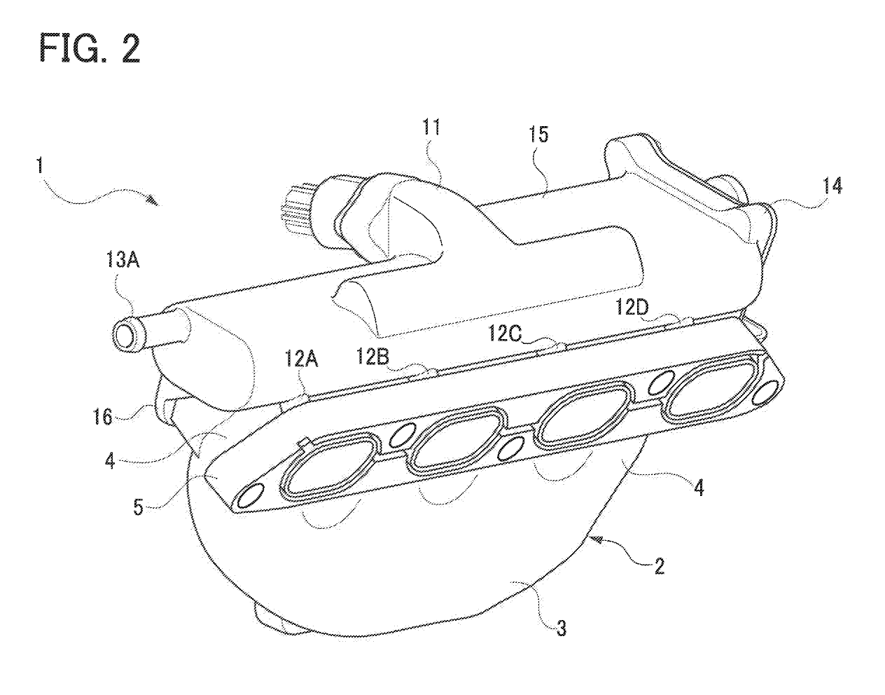

FIG. 1 is a perspective view of an EGR gas distributor 1. FIG. 2 is a perspective view of the EGR gas distributor 1 attached to an intake manifold 2. The posture of the gas distributor 1 shown in FIGS. 1 and 2 represents a configuration state of the EGR gas distributor 1 when attached to the intake manifold 2 mounted in an engine. The top and bottom of the EGR gas distributor 1 are oriented as shown in FIGS. 1 and 2. The intake manifold 2 is provided, as is known, with a surge tank 3, a plurality of branch pipes 4 branched from the surge tank 3, and an outlet flange 5 connecting each of the branch pipes 4 to the engine. In the present embodiment, the intake manifold 2 includes four branch pipes 4 corresponding to a 4-cylinder engine and is made of resin. The EGR gas distributor 1 is an attachment device to he attached to the intake manifold 2 in use to distribute EGR gas to each of the branch pipes 4 of the intake manifold 2.

(Outline of EGR Gas Distributor)

The EGR gas distributor 1 is provided, in appearance as shown in FIG. 1, with a gas inflow pipe 11 protruding backward from the center of an upper surface of the EGR gas distributor 1, a plurality of gas distribution pipes 12A, 12B, 12C, and 12D each protruding obliquely downward from a front surface of the EGR gas distributor 1, a pipe joint 13A protruding sideways from a left side surface of the EGR gas distributor 1, a pipe joint 13B protruding downward from a right lower surface of the EGR gas distributor 1, a flange 14 formed on a right side, an EGR cooler 15 provided adjacent to the flange 14, and a bracket 16 to fax the EGR gas distributor 1 to the intake manifold 2. The EGR gas distributor 1 can be made of a resin material having good thermal conductivity. For example, the resin material having good thermal conductivity can be a resin material mixed with carbon powder.

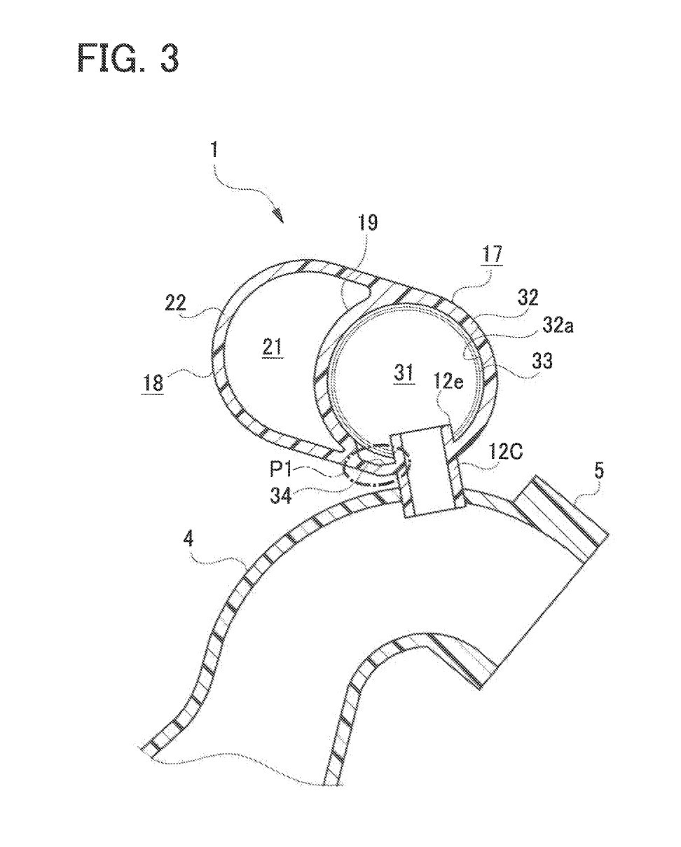

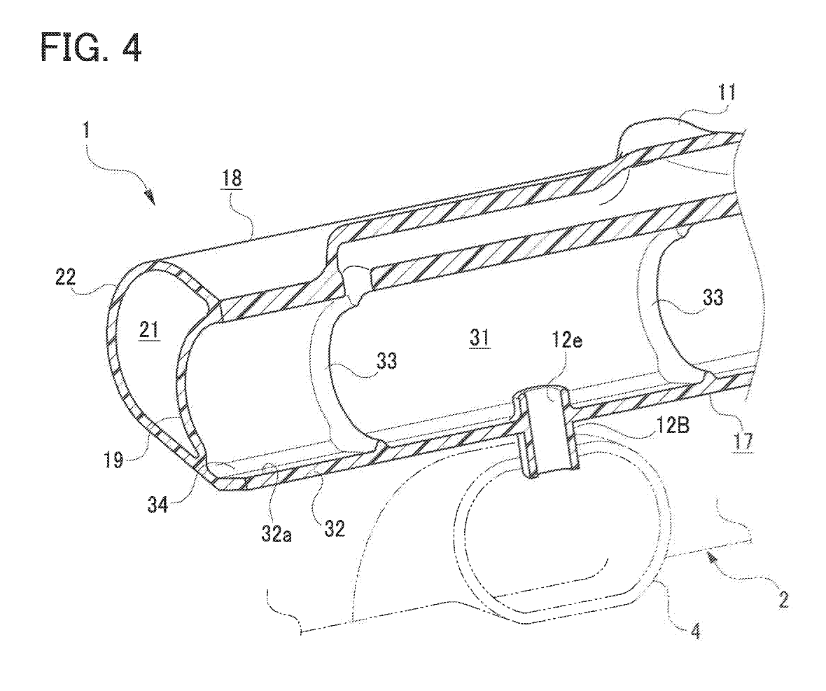

FIG. 3 is a cross-sectional view of the EGR gas distributor and the intake manifold 2 shown in FIG. 2, taken along a vertical plane perpendicular to the longitudinal direction (i.e., the center axis) of the EGR gas distributor 1 at a position corresponding to the gas distribution pipe 12C. FIG. 4 is a perspective cutaway view of a part of the EGR gas distributor 1 and a part of the intake manifold 2 shown in FIG. 2. As shown in FIGS. 3 and 4, the EGR gas distributor 1 includes a gas distribution part 17 configured to allow EGR gas to flow therein and to distribute the EGR gas to each of the branch pipes 4 of the intake manifold 2, and a heating part 18 configured to heat the gas distribution part 17. The gas distribution part 17 and the heating part 18 are arranged adjacent to each other through a partition wall 19. A part of the heating part 18 is interposed between the EGR cooler 15 and the gas distribution part 17. In the present embodiment, in a cross-section of a chamber case 32 mentioned later, taken along a vertical plane perpendicular to the longitudinal direction of the chamber case 32, the partition wall 19 is curved in a convex shape toward the heating part 18. In the present embodiment, the number (four) of gas distribution pipes 12A to 12D and the position of the gas inflow pipe 11 (the center position) are merely examples.

(Heating Part)

The heating part 18 is configured to allow cooling water (hot water) of the engine to flow through the heating part 18 in order to heat the gas distribution part 17. Specifically, the heating part 18 is constituted of a passage case 22 having a water passage 21 in which engine cooling water (hot water) flows. The passage case 22 is formed with the foregoing pipe joints 13A and 13B. In the present embodiments, as shown in FIGS. 3 and 4, a part of the passage case (i.e., a portion of the passage case 22, not interposed between the EGR cooler 15 and the gas distribution part 17) has a substantially U-shaped cross-sectional shape including a semi-circular portion and a straight portion.

(Gas Distribution Part)

The gas distribution part 17 includes: a chamber case 32 having a gas chamber 31 configured to allow EGR gas to flow therein and extend in a direction traversing the plurality of branch pipes 4; the foregoing gas inflow pipe 11 provided in the chamber case 32 and configured to introduce EGR gas into the gas chamber 31; and the plurality of gas distribution pipes 12A to 12D branched from the chamber case 32 and arranged at intervals in the longitudinal direction of the chamber case 32 to distribute the EGR gas from the gas chamber 31 to each of the branch pipes 4. In the present embodiment, the gas chamber 31 includes a lowermost portion P1 which will be located at a lowermost position in a usage state of the gas chamber 31. Each gas distribution pipe 12A to 12D opens toward an outlet port of each corresponding branch pipe 4. In the present embodiment, as shown in FIGS. 3 and 4, the chamber case 32 and the partition wall 19 each have a circular arc cross-sectional shape, so that a combination of the chamber case 32 and the partition wall 19 provides a substantially circular cross-sectional shape. In the present embodiment, furthermore, the passage case 22 of the heating part 18 and the chamber case 32 of the gas distribution part 17 are made of resin by integral molding.

Herein, the gas distribution part 17 is provided with a plurality of condensed-water flow restraining units configured to restrain condensed water generated in the gas chamber 31 from flowing in the gas distribution pipes 12A to 12D. In the present embodiment, these condensed-water flow restraining units include different types of condensed-water flow restraining units. Specifically, the first type of the condensed-water flow restraining units is provided as a plurality of ribs 33 formed on an inner wall 32a of the chamber case 32 so that each rib 33 is located between adjacent two of the gas distribution pipes 12A to 12D and extends in a circumferential direction around the longitudinal direction (i.e., the central axis) of the chamber case 32. Herein, when a vehicle mounted with an engine makes for example a sharp turn, a centrifugal force also acts on the EGR gas distributor 1. Thus, each rib 33 has only to be designed with a height enough to at least prevent the condensed water adhering to the inner wall 32a of the chamber case 32 from climbing over the rib(s) 33 even if the condensed water is moved on the inner wall 32a by the centrifugal force acting in the longitudinal direction of the chamber case 32. The second type of the condensed-water flow restraining units is constituted of an upper end portion 12e of each of the gas distribution pipes 12A to 12D, each upper end portion 12e being formed to protrude into the gas chamber 31. Herein, the upper end portions 12e each have only to be designed with a protruding height enough to at least prevent the condensed water that may accumulate in the lowermost portion P1 of the gas chamber 31 within a predetermined period from overflowing beyond the upper end portion 12e. The third type of the condensed-water flow restraining units is a groove 34 formed in the chamber case 32 along the longitudinal direction thereof in correspondence with the lowermost portion P1 of the gas chamber 31 to trap condensed water. Herein, the groove 34 has only to be designed with a depth enough to prevent the condensed water that may accumulate in the groove 34 within a predetermined period from overflowing from the groove 34.

According to the configuration of the present embodiment described above, the EGR gas distributor 1 is attached to the intake manifold 2 mounted on the engine. In this attached state, EGR gas introduced into the gas chamber 1 of the gas distribution part 17 through the gas inflow pipe 11 is distributed from the gas chamber 31 to the branch pipes 4 through the corresponding gas distribution pipes 12A to 12D. Herein, during cold start of the engine, condensed water may be generated in the gas chamber 31 from EGR gas introduced into the gas chamber 31. Further, this condensed water may adhere to the inner wall 32a of the chamber case 32, flow down by its own weight along the inner wall 32a and collect in the lowermost portion P1 of the gas chamber 31. Herein, the EGR gas distributor 1 is provided with the condensed-water flow restraining units configured to restrain the condensed water generated in the gas chamber 31 from flowing in the gas distribution pipes 12A to 12D. Accordingly, the condensed-water flow restraining units restrain flowing of the condensed water into the gas distribution pipes 12A to 12D, thereby making it less likely to cause the condensed water to flow in each branch pipe 4. This configuration can therefore restrain the condensed water generated in the gas chamber 31 from being sucked into the engine through the gas distribution pipes 12A to 12D and the branch pipes 4 of the intake manifold 2. Consequently, it is possible to prevent misfire in the engine due to suction of the condensed water.

According to the configuration of the present embodiment, as the first type of the condensed-water flow restraining units, the ribs 33 are formed on the inner wall 32a of the chamber case 32 in the circumferential direction around the longitudinal direction of the chamber case 32. Thus, even if the condensed water on the inner wall is moved in the longitudinal direction of the chamber case 32 by action of the centrifugal force and the like, the movement of the condensed water is restricted by each rib 33 and thus the condensed water will not lean to one end part of the chamber case 32 in the longitudinal direction. It is thus possible to restrain the condensed water that leans to and accumulates in the end part of the chamber case 32 from flowing in specific gas distribution pipes 12A and 12D, i.e., the gas distribution pipes 12A and 12D located near the end part of the chamber case 32. Thus, the condensed water will not ununiformly flow into the branch pipes 4 corresponding to the gas distribution pipes 12A and 12D. This configuration can restrain the condensed water generated in the gas chamber 31 from being sucked into the engine through the specific gas distribution pipes 12A and 12D near the end part of the chamber case 32 and the corresponding branch pipes 4.

According to the configuration of the present embodiment, as the second type of the condensed-water flow restraining units, the upper end portion 12e of each of the gas distribution pipes 12A to 12D is formed to protrude into the gas chamber 31. Thus, the condensed water generated in the gas chamber 31 collects by its own weight into the lowermost portion P1 that is a lower area of the gas chamber 31; however, the upper end portions 12e of the gas distribution pipes 12A to 12D protruding into the gas chamber 31 restrain the collected condensed water from flowing in the gas distribution pipes 12A to 12D, so that the condensed water is less likely to flow in each branch pipe 4. Accordingly, this configuration can prevent the condensed water generated in the gas chamber 31 from being sucked into the engine through the gas distribution pipes 12A to 12D and the branch pipes 4.

According to the configuration of the present embodiment, as the third type of the condensed-water flow restraining units, the groove 34 is formed in the longitudinal direction of the chamber case 32 in correspondence with the lowermost portion P1 of the gas chamber 31. Thus, the condensed water generated in the gas chamber 31 that flows down by its own weight is trapped in the groove 34, so that the condensed water is less likely to flow in each of the gas distribution pipes 12A to 12D. Accordingly, this configuration can prevent the condensed water generated in the gas chamber 31 from being sucked into the engine through the gas distribution pipes 12A to 12D and the branch pipes 4.

According to the configuration of the present embodiment, the heating part 18 is provided adjacent to the gas distribution part 17. Thus, the inner wall 32a of the chamber case 32 of the gas distribution part 17 is heated by the heating part 18 and thus the EGR gas in the gas chamber 31 is warmed up. This configuration can therefore reduce the generation of condensed water in the gas chamber 31 and also promote evaporation of condensed water, even if generated.

In the EGR gas distributor 1 in the present embodiment, as the condensed-water flow restraining units, (1) the ribs 33 are formed on the inner wall 32a of the chamber case 32 and extend in the circumferential direction of the chamber case 32, (2) the upper end portions 12e are formed in the gas distribution pipes 12A to 12D and protrude into the gas chamber 31, and (3) the groove 34 is formed in the longitudinal direction of the chamber case 32 in correspondence with the lowermost portion P1 of the gas chamber 31. In addition, (4) the heating part 18 for heating the chamber case 32 is provided adjacent to the chamber case 32. In the present embodiment, furthermore, the above configurations (1) to (4) act synergistically on the special effects that can prevent the condensed water that has been generated or is generated in the gas chamber 31 from being sucked into the engine through the gas distribution pipes 12A to 12D and the branch pipes 4. However, the EGR gas distributor 1 has only to include at least one of the configurations (1) to (3) as a base configuration to ensure the foregoing special effects.

### Second Embodiment

Next, a second embodiment of the EGR gas distributor will be described below with reference to the accompanying drawings.

In the following description, similar or identical components to those in the first embodiment are assigned the same reference signs and their details are omitted. The following description is thus given with a focus on differences from the first embodiment.

(Configuration of EGR Gas Distributor)

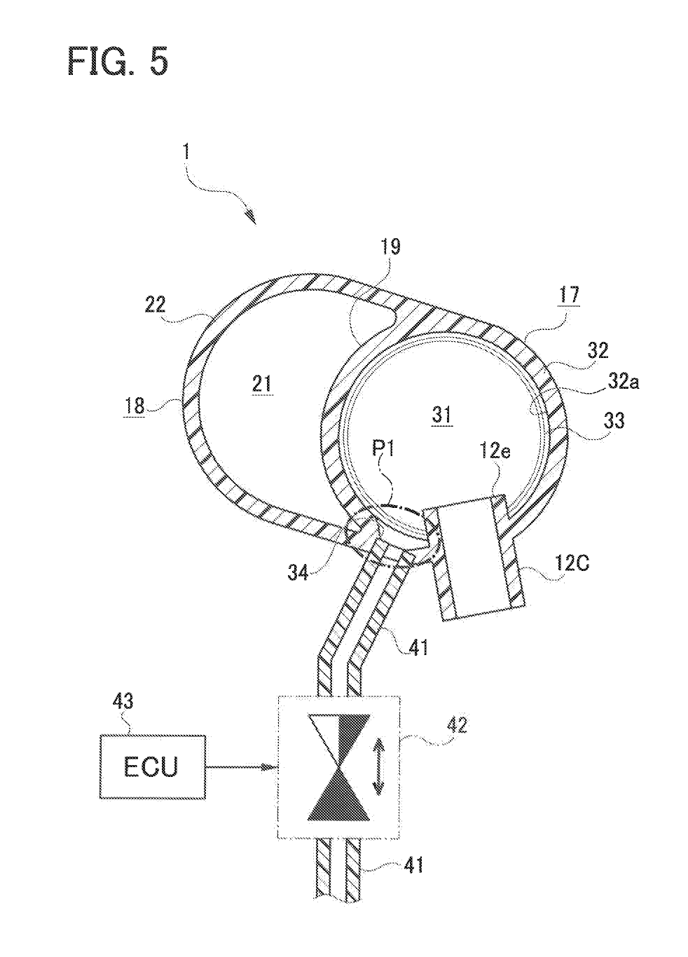

FIG. 5 is a cross-sectional view of the EGR gas distributor 1. in the present embodiment, corresponding to the cross-sectional view of FIG. 3. The EGR gas distributor 1 in the present embodiment further includes a condensed-water discharging unit configured to discharge the condensed water trapped in the groove 34 to the outside of the EGR gas distributor 1 as needed. In the present embodiment, as shown in FIG. 5, the condensed-water discharging unit is provided with a discharge passage 41 extending downward from the groove 34, an electromagnetic valve 42 placed at an appropriate position in the discharge passage 41, and an electronic control unit (ECU) 43 to control the electromagnetic valve 42. An upper end of the discharge passage 41 is connected in communication with the groove 34. A lower end of the discharge passage 41 is connected in communication with a cooling-water passage in which the cooling water flowing out of the EGR cooler 15 flows. Further, the ECU 43 is configured to control the electromagnetic valve 42 according to an operating state of an engine. Specifically, the ECU 43 is configured to open the electromagnetic valve 42 only for a predetermined time after start of the engine to discharge condensed water and, after a lapse of the predetermined time, close the electromagnetic valve 42.

Accordingly, the configuration of the EGR gas distributor 1 in the present embodiment can also achieve the operations and effects substantially equivalent to those in the first embodiment. In the present embodiment, additionally, the condensed water trapped in the groove 34 is drained out by the condensed-water discharging unit (the discharge passage 41, the electromagnetic valve 42, and the ECU 43) as needed, so that the condensed water does not accumulate in the chamber case 32. In other words, the condensed water trapped in the groove 34 of the chamber case 32 flows down into the discharge passage 41. Herein, when the electromagnetic valve 42 is in a valve-closed state, condensed water will accumulate mainly in the groove 34 and the discharge passage 41. In contrast, when the electromagnetic valve 42 is opened, condensed water is allowed to flow in the cooling-water passage through the electromagnetic valve 42 and the discharge passage 41 and then flow out of the EGR gas distributor 1. This configuration can prevent the condensed water from being sucked into the engine through the gas distribution pipes 12A to 12D and the branch pipes 4, and hence can prevent misfire in the engine due to suction of condensed water.

### Third Embodiment

Next, a third embodiment of the EGR gas distributor will be described below with the accompanying drawings.

(Configuration of EGR Gas Distributor)

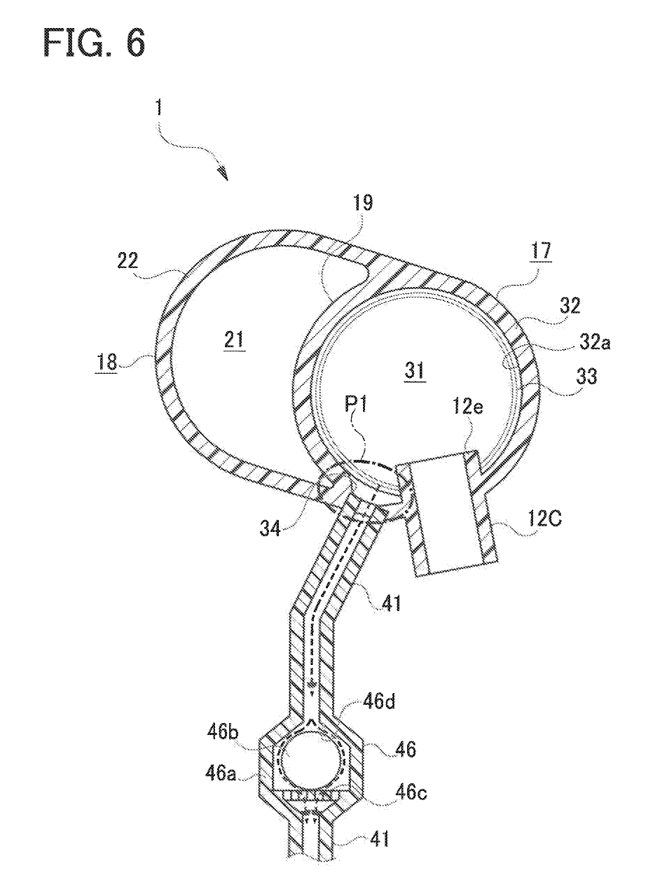

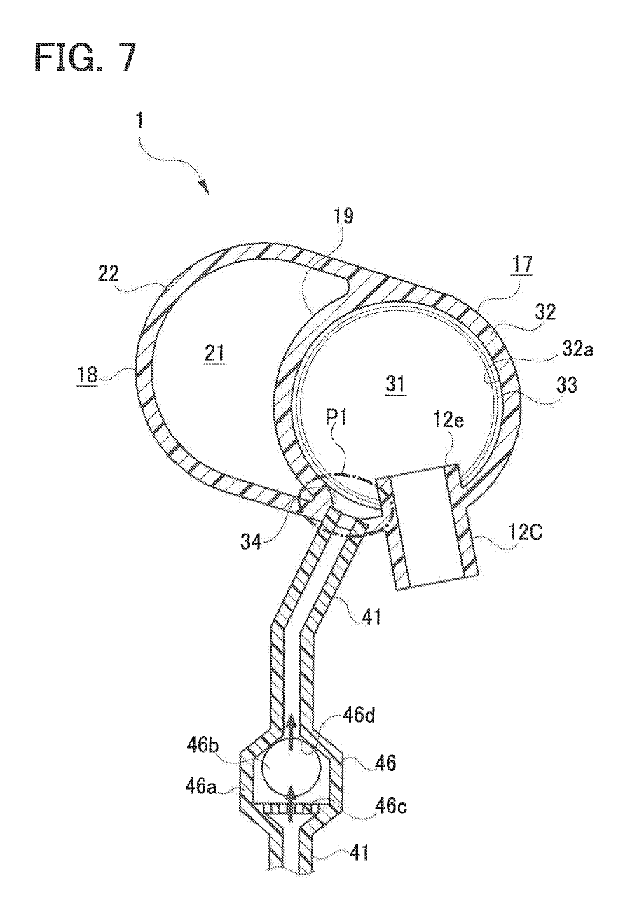

FIGS. 6 and 7 are cross-sectional views of the EGR gas distributor 1 in the present embodiment, corresponding to the cross-sectional view of FIG. 5. Specifically, FIG. 6 shows a state of the EGR gas distributor 1 during engine stop and FIG. 7 shows a state of the EGR gas distributor 1 during engine operation. The present embodiment differs from the second embodiment in the configuration of the condensed-water discharging unit. In the present embodiment, specifically, a check valve 46 is provided, instead of the electromagnetic valve 42, at an appropriate position in the discharge passage 41. This check valve 46 includes a casing 46a, a check ball 46b placed in the casing 46a, a ball holder 46c formed with slits and configured to support the check ball 46b in the casing 46a, and a valve seat 46d formed in the casing 46a above the check ball 46b. In the present embodiment, a lower end of the discharge passage 41 is connected in communication with an exhaust passage of an engine. Thus, as shown in FIG. 6, during engine stop, the check ball 46b falls down by its own weight, separating from the valve seat 46d (Valve opening), and the check ball 46b is supported on the ball holder 46c. During engine operation, as shown in FIG. 7, intake negative pressure acting on the gas chamber 31 through the intake manifold 2 causes the check ball 46b to be drawn toward the gas chamber 31 and thus be seated on the valve seat 46d (Valve closing).

Consequently, the configuration of the EGR gas distributor 1 in the present embodiment can also achieve the operations and effects substantially equivalent to those in the second embodiment. In the present embodiment, additionally, the check valve 46 is used instead of the electromagnetic valve 42 to discharge condensed water, so that the electrical configuration including the ECU 43 and wiring or others to those components can be omitted, resulting in simplification of the condensed-water discharging unit.

### Fourth Embodiment

Next, a fourth embodiment of the EGR gas distributor will be described below with the accompanying drawings.

(Configuration of EGR Gas Distributor)

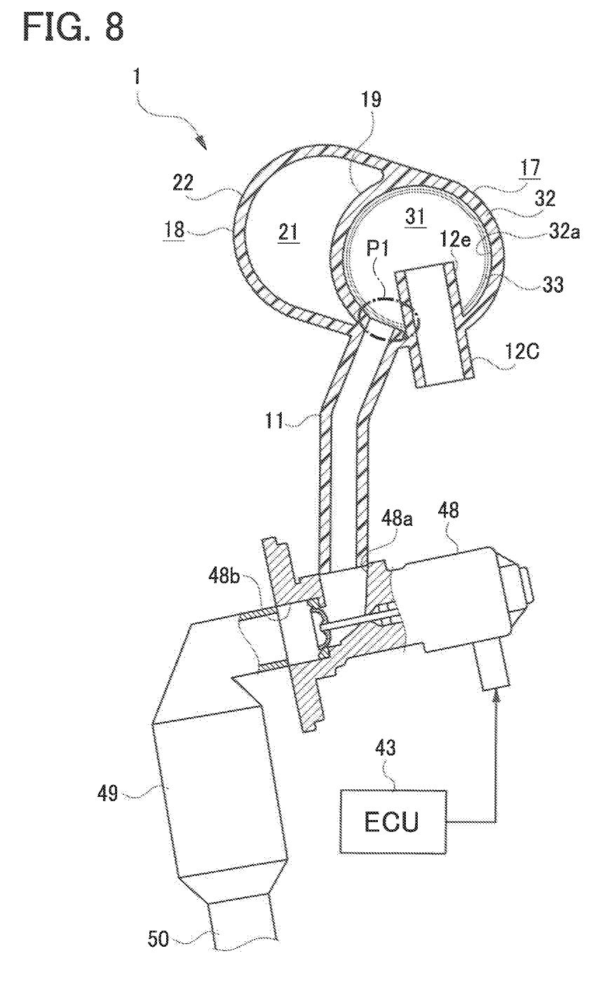

FIG. 8 is a cross-sectional view of the EGR gas distributor 1 and others (including a partial cutaway view of some devices) in the present embodiment. The present embodiment differs from the second and third embodiments in the configuration and others of the condensed-water discharging unit. In the EGR gas distributor 1 in the present embodiment, specifically, the EGR cooler 15 placed between the heating part 18 and the gas distribution part 17 and the groove 34 in the chamber case 32 are omitted and instead a condensed-water discharging unit is provided to discharge the condensed water collected in the lowermost portion P1 of the gas chamber 31 to the outside of the EGR gas distributor 1 as needed. The condensed-water discharging unit in the present embodiment is provided, as shown in FIG. 8, with a gas inflow pipe 11 extending downward from the lowermost portion P1 of the gas chamber 31, an EGR valve 48 connected to one of the gas inflow pipe 11, an EGR cooler 49 and an EGR passage 50 connected to the EGR valve 48, and an ECU 43 to control the EGR valve 48. An upper end of the gas inflow pipe 11 is opened to communicate with the lowermost portion P1 of the gas chamber 31. An upper end portion 12e of each gas distribution pipe 12A to 12D is designed to protrude in the gas chamber 31 by a protruding length longer than that in other embodiments. This is to prevent EGR gas introduced from the gas inflow pipe 11 to the gas chamber 31 from directly flowing in the gas distribution pipes 12A to 12D. A lower end of the gas inflow pipe 11 is connected to an outlet 48a of the EGR valve 48. An inlet 48b of the EGR valve 48 is connected to an outlet of the EGR cooler 49. An inlet of the EGR cooler 49 is connected to an exhaust passage of an engine through the EGR passage 50. Herein, the EGR valve 48, the EGR cooler 49, and the EGR passage 50 are arranged to slope downward toward the exhaust passage. The ECU 43 is configured to control the EGR valve 48 (Valve opening or Valve closing) according to an operating state of the engine.

Accordingly, the configuration of the EGR gas distributor 1 in the present embodiment can also achieve the operations and effects substantially equivalent to those in the second embodiment. In the present embodiment, additionally, the condensed water generated in the gas chamber 31 collects by its own weight in the lowermost portion P1 of the gas chamber 31. This condensed water that collects in the lowermost portion P1 is appropriately discharged outside through the condensed-water discharging unit (the gas inflow pipe 11, the EGR valve 48, the EGR cooler 49, the EGR passage 50, acid the ECU 43), so that the condensed water does not accumulate in the chamber case 32. In other words, the condensed water that collects in the lowermost portion P1 of the gas chamber 31 flows down to the EGR valve 48 through the gas inflow pipe 11. Herein, when the EGR valve 48 is in a valve-closed state, the condensed water accumulates mainly in the gas inflow pipe 11 and the lowermost portion P1. In contrast, when the EGR valve 48 is opened, the condensed water is allowed to flow to the discharge passage through the EGR valve 48, the EGR cooler 49, and the EGR passage 50 and then the condensed water is discharged outside. This configuration can prevent the condensed water from being sucked into the engine through the gas distribution pipes 12A to 12D and the branch pipes 4, and hence can prevent misfire in the engine due to suction of condensed water.

The present disclosure is not limited to each of the aforesaid embodiments and may be embodied in other specific forms without departing from the essential characteristics thereof.

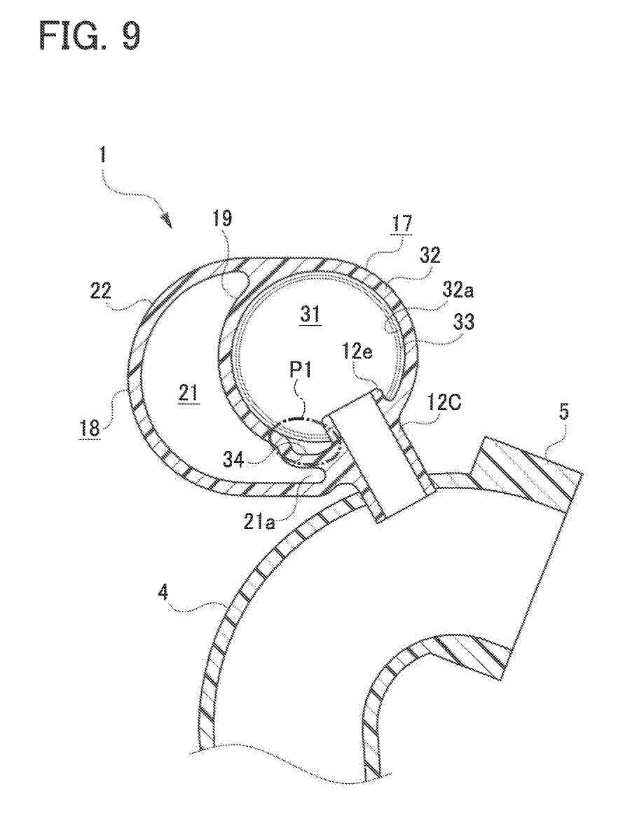

In the first embodiment, as shown in FIG. 3, the heating part 18 is configured to heat the inner wall of the gas distribution part 17 (the chamber case 32) with engine cooling water (hot water). As an alternative, as shown in FIG. 9, a part of the water passage 21 of the heating part 18 may be designed to extend under the groove 34, forming an extended portion 21a, to actively heat the inner wall defining the groove 34. FIG. 9 is a cross-sectional view of the EGR gas distributor 1, corresponding to the cross-sectional view of FIG. 3.

In each of the foregoing embodiments, the EGR gas distributor 1 is used to distribute EGR gas to each of the branch pipes 4 of the intake manifold 2. As an alternative, this EGR gas distributor 1 may also be used to distribute auxiliary gas (e.g., PCV gas) different from EGR gas to each branch pipe 4 of the intake manifold 2.

In each of the foregoing embodiments, the upper end portion 12e of each of the gas distribution pipes 12A to 12D is configured to protrude in the gas chamber 31, but this configuration may be omitted.

In each of the foregoing embodiments, the ribs 33 are provided on the inner wall 32a of the chamber case 32, but these ribs 33 may be omitted.

In each of the foregoing embodiments, the heating part 18 is provided to heat the gas distribution part 17, but this heating part 18 may be omitted.

### INDUSTRIAL APPLICABILITY

The present disclosure is utilizable in an EGR device and a PCV device provided in an engine system.

### REFERENCE SIGNS LIST

1 EGR gas distributor
2 Intake manifold
4 Branch pipe
11 Gas inflow pipe (Condensed-water discharging unit)
12A to 12D Gas distribution pipe
12e Upper end portion (Condensed-water flow restraining unit)
17 Gas distribution part
18 Heating part
19 Partition wall
31 Gas chamber
32 Chamber case
33 Rib (Condensed-water flow restraining unit)
34 Groove (Condensed-water flow restraining unit)
41 Discharge passage (Condensed-water discharging unit)
42 Electromagnetic valve (Condensed-water discharging unit)
43 ECU (Condensed-water discharging unit)
46 Check valve (Condensed-water discharging unit)
48 EGR valve (Condensed-water discharging unit)
49 EGR cooler (Condensed-water discharging unit)
EGR passage (Condensed-water discharging unit)

What is claimed is:

1. An EGR gas distributor that is an attachment device to be attached to an intake manifold and is configured to distribute EGR gas to each of a plurality of branch pipes constituting the intake manifold, the EGR gas distributor comprising:
a chamber case including a gas chamber configured to allow the EGR gas to flow therein, the chamber case extending in a direction traversing the plurality of branch pipes;
a gas inflow pipe provided in the chamber case and configured to introduce the EGR gas into the gas chamber;
a plurality of gas distribution pipes branched from the chamber case and arranged at intervals in a longitudinal direction of the chamber case to distribute the EGR gas to the plurality of branch pipes; and
a condensed-water flow restraining unit configured to restrain condensed water generated in the gas chamber from flowing into the gas distribution pipes.

2. The EGR gas distributor according to claim 1, wherein the condensed-water flow restraining unit is a rib formed on an inner wall of the chamber case between adjacent two of the gas distribution pipes, the rib extending in a circumferential direction around the longitudinal direction of the chamber case.

3. The EGR gas distributor according to claim 1, wherein
the plurality of gas distribution pipes are formed to protrude downward from the chamber case, and
the condensed-water flow restraining unit is constituted of an upper end portion of each of the gas distribution pipes, the upper end portion being formed to protrude into the gas chamber.

4. The EGR gas distributor according to claim 1, wherein
the gas chamber includes a lowermost portion in a usage state of the gas chamber, and
the condensed-water flow restraining unit is a groove formed in the chamber case, the groove extending in the longitudinal direction of the chamber case in correspondence with the lowermost portion of the gas chamber to trap the condensed water.

5. The EGR gas distributor according to claim 1 further comprising a heating part configured to heat the chamber case and provided adjacent to the chamber case.

6. The EGR gas distributor according to claim 2 further comprising a heating part configured to heat the chamber case and provided adjacent to the chamber case.

7. The EGR gas distributor according to claim 3 further comprising a heating part configured to heat the chamber case and provided adjacent to the chamber case.

8. The EGR gas distributor according to claim 4 further comprising a heating part configured to heat the chamber case and provided adjacent to the chamber case.

9. The EGR gas distributor according to claim 4 further comprising a condensed-water discharging unit configured to discharge the condensed water trapped in the groove to outside of the EGR gas distributor as needed.

10. The EGR gas distributor according to claim 3, wherein
the gas chamber includes a lowermost portion in a usage state of the gas chamber, and
the EGR gas distributor further comprises a condensed-water discharging unit configured to discharge the condensed water that collects in the lowermost portion to outside of the EGR gas distributor as needed.
